(19) United States
(12) Patent Application Publication
(10) Pub. No.: US 2008/0032835 A1
(43) Pub. Date: Feb. 7, 2008

(54) Multiple Sprocket Chain Guide For Front Bicycle Derailleur

(76) Inventor: Mark A. Reynolds, San Jose, CA (US)

Correspondence Address: BEVER HOFFMAN & HARMS, LLP;TRI-VALLEY OFFICE, 1432 CONCANNON BLVD., BLDG. G, LIVERMORE, CA, 94550, US

(21) Appl. No.: 11/833,856

(22) Filed: Aug. 3, 2007

Related U.S. Application Data
(60) Provisional application No. 60/821,397, filed on Aug. 4, 2006.

(51) Int. Cl. F16H 59/00

(52) U.S. Cl. 474/80

(57) ABSTRACT

A multiple sprocket chain guide includes a guide structure mounted onto the movable metal cage of a conventional front bicycle derailleur such that the entire guide structure moves between inner and outer gear positions with the movable cage. The guide structure includes opposing outer and inner guide plates and a bridge that is rigidly connected between the guide plates to define a chain guide channel for directing the bicycle's chain onto a selected front sprocket. When the derailleur is positioned to guide the chain onto the outer front sprocket, the outer guide plate is positioned over the outer bash guard such that a gap there between is smaller than the height of the chain, thereby preventing derailment. When the derailleur is positioned to guide the chain onto the inner front sprocket, the inner guide plate is positioned over an inner plate to prevent derailment in a similar manner.

### RELATED APPLICATION

This application claims priority of U.S. Provisional Patent Application 60/821,397, entitled “Dualrailleur Guide” filed Aug. 4, 2006.

### FIELD OF THE INVENTION

This invention relates to generally to bicycles and particularly to those having multiple sprocket chain drive systems used in off-road cycling, or mountain biking.

### BACKGROUND OF THE INVENTION

The drivetrain of a bicycle is subjected to extreme conditions during the sport of downhill bicycle racing or when the bicycle is used for stunts and jumps or when it is used to surmount or descend unfriendly surfaces such as boulders, logs, stairs and the like. Such extreme uses cause the chain to whip and flex in many directions consequently with the conventional front derailleur the chain has many opportunities to jump from ring to ring causing the inability for the rider to pedal as needed. In addition the chain has ample opportunity to derail from the front sprocket in either the inboard or outboard direction resulting in the chain falling off all together.

To minimize the chance of breakage or failure of the forward part of the bicycle drivetrain during the above-described activities, rims or guide rings (“bash guards”) made of metal or resin have been affixed to the bicycle crank parallel with the front sprocket by means of the sprocket mounting holes in the crank, either on the outboard side only or on both the outboard and inboard sides of the sprocket. These guide rings are conventionally of a diameter exceeding that of the tops of the sprocket teeth and are positioned laterally far enough from the sprocket to allow clearance for the chain while being close enough to guide the chain back onto the sprocket if violent shaking of the bike and consequent whipping motion of the chain begins to derail. This has worked adequately as long as you are running only one front chain ring. This limits the ability of the bike to change gear ratios for climbing steep terrain.

What is needed is a multiple sprocket chain guide that works in conjunction with (or is integrally formed on) a front bicycle derailleur to both constrict the whipping action of the chain and to reliably guide the chain onto a selected front sprocket, thereby both avoiding chain derailment and facilitating changes between front sprockets to better compensate for the changing terrain.

### SUMMARY OF THE INVENTION

The present invention is directed to a multiple sprocket chain guide including movable inner and outer guide plates that work in conjunction with a conventional bash guard and back plate to form a substantially enclosed channel that reliably feeds a bicycle chain onto a selected front sprocket. When the drive chain is shifted onto the outer (larger) front sprocket, the outer guide plate is positioned over the outer bash guard such that a gap formed between a curved surface of the outer guide plate and the circular peripheral edge of the outer bash guard is smaller than a height of the drive chain, thereby preventing the drive chain from derailing from the outer front sprocket. In addition, the inner guide plate is positioned over the inner (smaller) sprocket in a manner that prevents the chain from dropping onto the inner (smaller) front sprocket. Conversely, the drive chain is shifted onto the inner front sprocket, the outer guide plate is positioned over the outer front sprocket and the inner guide plate is positioned over the back plate (or an inner bash guard) such that a gap formed between a curved surface of the inner guide plate and a curved peripheral edge of the back plate is smaller than a height of the drive chain, thereby preventing the drive chain from derailing from the inner front sprocket. The multiple sprocket chain guide of the present invention thus constricts the whipping action of the drive chain to reliably guide the drive chain to the selected front sprocket without derailment, and facilitates changing between two front sprockets to better compensate for the changing terrain.

In one embodiment, a multiple sprocket chain guide of the present invention includes a guide structure that is mounted onto a conventional front bicycle derailleur (e.g., as produced by Shimano, Inc. of Osaka, Japan or SRAM Corporation of Chicago, Ill., USA) to facilitate multiple sprocket operations. The conventional derailleur includes a base member that is fixedly connected to the bicycle frame, a movable metal cage having opposing (inner and outer) metal guide surfaces disposed on opposite sides of the drive chain, and a gear shifting mechanism that moves the movable cage between a first position in which the movable cage biases the drive chain to engage the outer (larger) front sprocket, and a second position in which the movable cage biases the chain drive to engage the inner (smaller) front sprocket. The guide structure includes an aluminum anchor plate that is fixedly connected to the inner metal guide blade of the derailleur's movable cage, an outer guide plate that is mounted over and abuts the outer metal guide blade, and a bridge that is rigidly connected between the anchor plate and the outer guide plate. In one embodiment, the bridge and the outer guide plates and the bridge are molded, machined or otherwise formed from a hard plastic (e.g., polycarbonate or other polymeric resin) or other suitable material, and are shaped to tightly fit over the movable portion of a selected conventional front derailleur. A channel is defined between the outer guide plate and the anchor plate that constricts the whipping action of the chain from all sides as the chain travels into and through the channel. The surface area of the guard is approximately 2.5× greater on the inner plate, 3× on the outer plate, and also has 4× more surface area on the bridge than the corresponding guide surfaces provided by the metal cage of a standard derailleur. This combination greatly enhancing the ability to control the chain and calm any chain whip before it comes in contact with the front sprocket. Unlike previous chain guides that only allowed the use of one sprocket, the present invention allows full advantage of a dual ring chain configuration which enhances a rider's ability to maneuver steeper terrain and promotes safety.

### BRIEF DESCRIPTION OF THE DRAWINGS

These and other features, aspects and advantages of the present invention will become better understood with regard to the following description, appended claims, and accompanying drawings, where:

FIG. 1 is a side perspective view showing a bicycle including a multiple sprocket chain guide apparatus according to an embodiment of the present invention;

FIG. 2 is a top side perspective view showing a conventional derailleur utilized in the multiple sprocket chain guide apparatus of FIG. 1;

FIGS. 3(A) and 3(B) are simplified end views showing the conventional derailleur of FIG. 2 during operation;

FIGS. 4(A) and 4(B) are exploded front and back side perspective views showing a guide structure utilized in the multiple sprocket chain guide apparatus of FIG. 1;

FIGS. 5(A) and 5(B) are front and back side perspective views showing the guide structure of FIGS. 4(A) and 4(B) in an assembled state;

FIG. 6 is an exploded front side perspective view showing the multiple sprocket chain guide apparatus of FIG. 1;

FIGS. 7(A), 7(B), 7(C) and 7(D) are front side perspective views illustrating an assembly operation of the multiple sprocket chain guide apparatus of FIG. 6;

FIG. 8 is a rear side perspective view showing the multiple sprocket chain guide apparatus of FIG. 6 in an assembled state;

FIG. 9 is a front side perspective view showing the multiple sprocket chain guide apparatus of FIG. 1 in relation to a back plate and roller assembly according to an embodiment of the present invention;

FIG. 10 is a partial front side perspective view showing the multiple sprocket chain guide apparatus and back plate and roller assembly in relation to a bicycle drivetrain;

FIG. 11 is an end elevation view showing the multiple sprocket chain guide apparatus and back plate and roller assembly of FIG. 10 in a first gear position;

FIG. 12 is a front elevation view showing the multiple sprocket chain guide apparatus and back plate and roller assembly in the first gear position of FIG. 11;

FIG. 13 is an end elevation view showing the multiple sprocket chain guide apparatus and back plate and roller assembly of FIG. 10 in a second gear position; and

FIG. 14 is a partial perspective view showing the positional relationship between the multiple sprocket chain guide apparatus and the back plate and roller assembly in the second gear position of FIG. 13.

### DETAILED DESCRIPTION OF THE DRAWINGS

The present invention relates to an improvement in chain guides for off-road cycling or mountain biking. The following description is presented to enable one of ordinary skill in the art to make and use the invention as provided in the context of a particular application and its requirements. As used herein, directional terms such as “upper”, “upwards”, “lower”, “downward”, “front”, “rear”, “outer”, “outboard”, “inner” and “inboard” are intended to provide relative positions for purposes of description, and are not intended to designate an absolute frame of reference. In addition, the phrases “integrally connected”, “integrally formed” and “integrally molded” is used herein to describe the connective relationship between two portions of a single molded or machined structure, and are distinguished from the terms “connected” or “coupled” (without the modifier “integrally”), which indicates two separate structures that are joined by way of, for example, adhesive, fastener, clip, or movable joint. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

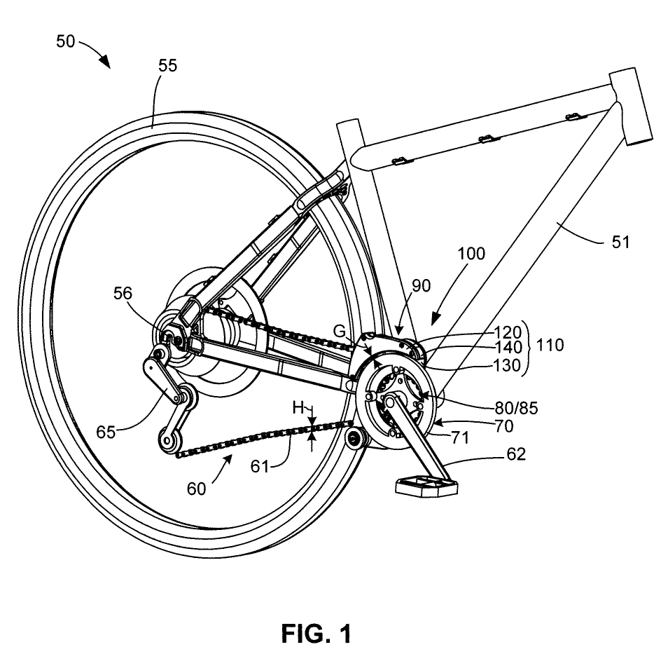

FIG. 1 shows a perspective view of a multiple sprocket chain guide apparatus 100 mounted onto a conventional bicycle 50. Bicycle 50 is an otherwise conventional off-road or mountain bike including a frame 51, a rear wheel 55 rotatably supported by frame 51 utilizing a rear axle 56, and a drive system 60. Drive train system 60 and its relationship to multiple sprocket chain guide apparatus 100 is described in additional detail in the following paragraphs. Other portions of bicycle 50, such as a front wheel, a seat and a steering system, operate in a conventional manner and are omitted herein for brevity.

Drive system 60 functions in a substantially conventional manner (with exceptions that are discussed below) to transfer energy from a rider to rear wheel 55 by way of a drive chain 61 and a pair of pedal cranks 62 (one shown). Pedal cranks 62 are connected by a pedal crank shaft that is rotatably supported on a bottom bracket of frame 51 in accordance with conventional techniques. A disk-shaped hard plastic (e.g., polycarbonate) outer bash guard 70 is fixedly connected to pedal crank 62 such that bash guard 70 rotates with pedal crank 62. An outer (first) front sprocket 80 and an inner (second) front sprocket 85 (both located behind bash guard 70 in FIG. 1 and generally indicated by arrow 80, 85) are fixedly secured to pedal cranks 62 such that front sprockets 80 and 85 are rotated with pedal cranks 62. Outer sprocket 80 has a larger diameter than inner sprocket 85, and bash guard 70 has a diameter that is slightly larger than outer sprocket 80 such that a substantially circular peripheral edge 71 extends above the gear teeth of outer sprocket 80. Drive chain 61 is fabricated in accordance with conventional techniques and has a height H. During operation, drive chain 61 is guided onto a selected front sprocket 80 or 85 by way of multiple sprocket chain guide apparatus 100, and is guided onto a selected rear sprocket provided on rear wheel 55 by way of an optional conventional rear derailleur 65.

In accordance with an embodiment of the present invention, multiple sprocket chain guide apparatus 100 includes a guide structure 110 that is mounted to and works in conjunction with a conventional front derailleur (which is located behind guide structure 110 in FIG. 1 and indicated by arrow 90) such that the entire guide structure 110 moves between inner and outer gear positions with the movable cage of conventional derailleur 90. The guide structure 110 includes an outer guide plate 120 and an opposing inner guide formed by an anchor plate 130 an inner side portion of a bridge structure 140. The outer and inner guide plates are rigidly connected by way of bridge structure 140 such that the guide plates and connecting bridge define a chain guide channel for directing chain 61 onto a selected front sprocket 80, 85 in a way that prevents derailment. That is, as described in additional detail below, when derailleur 90 is positioned to guide the chain 61 onto the outer front sprocket 80, the outer guide plate 120 is positioned over the outer bash guard 70 such that a gap G defined between outer guide plate 120 and outer bash guard 70 is smaller than the height H of the chain, thereby preventing chain 61 from dropping outside of bash guard 70. Conversely, as described in detail below, when derailleur 90 is positioned to guide the chain 61 onto inner front sprocket 85, the inner guide plate is positioned over an inwardly located back plate (or inner bash guard) to prevent derailment in a similar manner.

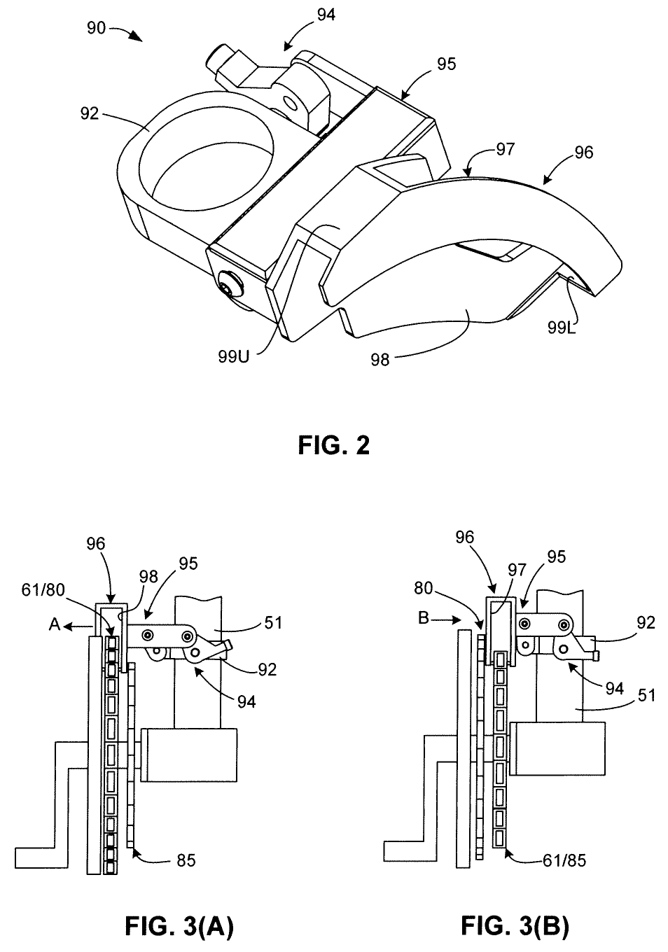

As mentioned above, in a presently preferred embodiment, multiple sprocket chain guide apparatus utilizes a conventional front derailleur to facilitate gear shifting between two front sprockets. FIG. 2 is a top perspective view showing an exemplary conventional front derailleur 90 that includes a base member 92 that includes a clamp (not shown) or other mechanism for fixedly connecting base 92 to the bicycle frame, a bracket 95, a movable metal cage 96 mounted on bracket 95 and having an outer (first) metal guide blade 97 and an opposing inner (second) metal guide blade 98 that are connected by an upper metal bridge 99U and a lower metal bridge 99L to define a channel through which the drive chain (not shown) passes, and a gear shifting mechanism 94 that is connected between base 92 and bracket 95. Gear shifting (i.e., cable and pulley) mechanism 94 consists of a parallel linkage that functions in a well known manner to selectively move bracket 95 and movable cage 96 outward and upward/downward at the same time during shifting between a first position (e.g., shown in FIG. 3(A)) in which gear shift mechanism 94 pushes movable cage 96 in the direction A such that first metal guide blade 97 biases drive chain 61 into operable engagement with outer front sprocket 80, and a second position (e.g., shown in FIG. 3(B)) in which in which gear shift mechanism 94 pushes movable cage 96 in the direction B such that second metal guide blade 98 biases drive chain 61 into operable engagement with inner front sprocket 85. Front derailleurs such as those shown in FIG. 2 and in FIGS. 3(A) and 3(B) are disclosed in additional detail, for example, in U.S. Pat. No. 7,186,194, which is incorporated herein by reference in its entirety. The specific embodiment described below includes features compatible with a Shimano XT M760 Front Derailleur produced by Shimano, Inc. of Osaka, Japan.

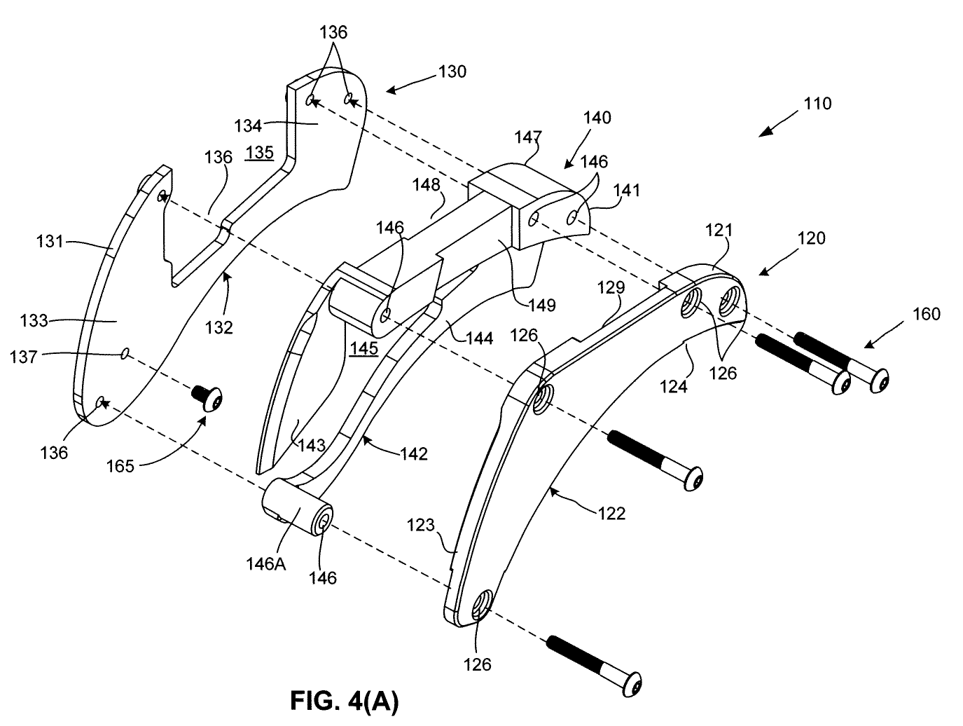

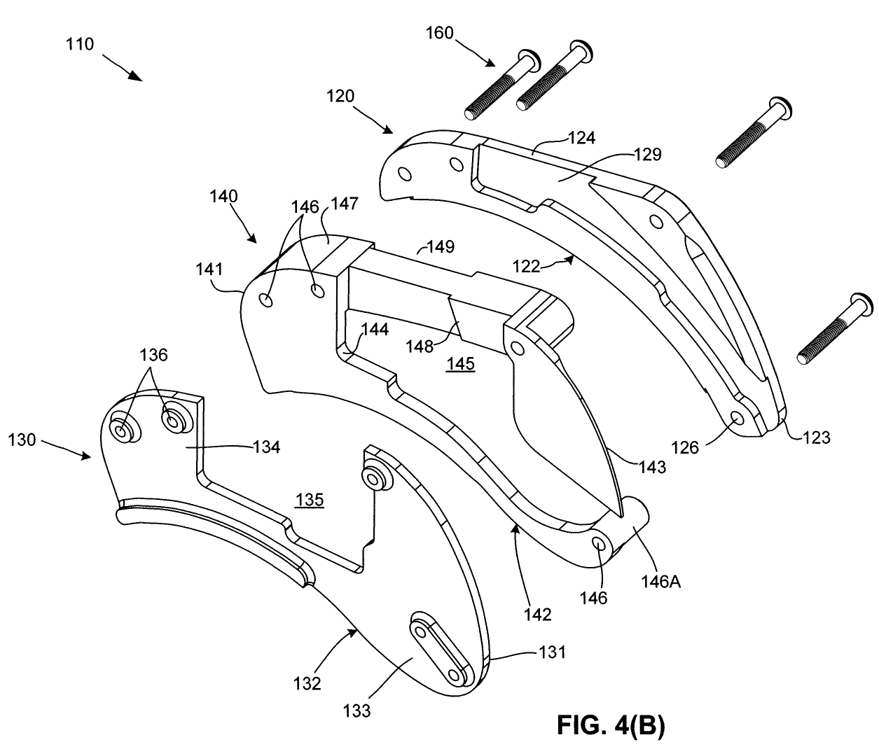

FIGS. 4(A) and 4(B) are front and rear exploded perspective view showing the components of a chain guide 110 of multiple sprocket chain guide apparatus 100 according to a presently preferred embodiment of the present invention. Chain guide 110 is mounted to and works in conjunction with front derailleur 90 in the manner described below to form multiple sprocket chain guide apparatus 100. Chain guide 110 generally includes a first (outer) guide plate 120, an anchor plate 130, and a bridge structure 140 that are secured together using long screws 160.

Referring again to FIGS. 4(A) and 4(B), outer guide plate 120 includes an integrally molded or machined single-piece body structure 121 preferably formed from a light weight, durable material (e.g., polycarbonate) that functions to provide one side of a chain guide channel in the manner described below. Body structure 121 defines a curved lower surface 122 that functions in the manner described below to prevent chain derailment. Body structure 121 includes a rear (first) portion 123 that faces the incoming chain and a front (second) portion 124 that faces forward when mounted on a bicycle. Multiple through-holes 126 are drilled or otherwise formed to facilitate assembly using long screws 160. Defined in an upper edge of body structure 121 is a groove 129 whose purpose is described below.

Anchor plate 130 includes an integrally formed single-piece metal body structure 131 preferably formed from aluminum that functions to rigidly connect chain guide 110 to derailleur 90 in the manner described below, and also to form a portion of a second side of the chain guide channel in the manner described below. Body structure 131 defines a curved lower surface 132 that functions in the manner described below to prevent chain derailment. Body structure 131 includes a rear (first) portion 133 that faces the incoming chain and a front (second) portion 134 that faces forward when mounted on a bicycle. A substantially U-shaped groove 135 is defined between rear portion 133 and front portion 134 for accommodating the front derailleur in the manner described below. Holes 136, which may be threaded or smooth, are defined at appropriate locations to facilitate assembly, and as shown in FIG. 4(B) may be embossed on the back side to provide more strength and surface area for receiving long (e.g., Allen) screws 160. Finally, an embossed derailleur connection hole 137 is provided for connecting anchor plate 130 to the front derailleur in the manner described below.

Bridge structure 140 includes an integrally molded/machined single-piece body structure 141 preferably formed from light-weight material (e.g., a hard plastic such as polycarbonate) that functions to rigidly connect outer guide plate 120 to anchor plate 130 such that an appropriate channel is formed there between, and also to form a portion of the second side of the chain guide channel. Body structure 141 defines a curved lower surface 142 that functions in the manner described below to prevent chain derailment. Body structure 141 includes a lower guide plate portion 144 that defines the entire length of lower surface 142, and functions in conjunction with anchor plate 130 to form an inner (second) guide plate structure for keeping the chain from dropping to a inner sprocket, or when in low gear, to keeps the chain from derailing completely inwardly. Body structure 141 also includes an upper (second) guide plate portion 143 that extends toward the rear of the bicycle and functions to guide the chain into the channel, and a bridge (flange) 147 that extends horizontally from upper guide plate portion 143 along and upper edge of body structure 141, and serves to space the inner guide plate (i.e., formed by anchor plate 130, lower guide plate portion 143 and upper guide plate portion 143) from outer guide plate 120 in order to form the required chain guide channel (described below). A central groove 145 is defined between lower guide plate portion 144 and upper guide plate portion 143. In addition, bridge 147 provides lateral stiffness to the entire assembly which improves shifting performance in all conditions, and provides an upper guide surface for the channel that restricts whipping of the chain above the derailleur. Through holes 146 are defined at appropriate locations to facilitate assembly, with a lowermost through hole 146 being defined through a cylindrical spacer 146A, which is integrally formed at a front end of lower guide plate portion 144. Defined on opposite sides of bridge 147 along the upper edge of body structure 141 are a first upper groove 148 and a second upper groove 149 whose purposes are described below.

The various contours and machine profiles depicted in FIGS. 4(A) and 4(B) are customized such that each of the parts fits snuggly onto corresponding portions of a selected derailleur and doesn't hinder the performance of the selected derailleur. Those skilled in the art will recognize that the depicted contours and shapes are therefore subject to change when a different derailleur is utilized. Further, although the various components of chain guide 110 are described above with reference to specific materials, it is understood that various alternative materials may be used as well. For example, instead of aluminum, anchor portion 130 may be formed using another suitable metal or hard material of comparable strength such as carbon fiber composite. Further, several alternatives to polycarbonate may be used to form any of the disclosed structures, but preferably such materials should be low friction to facilitate easy chain glide through the guide to the chosen sprocket. Depending on the particular material (e.g., a polymeric resin), it is possible to manufacture guides that are clear and/or translucent, and therefore have a more aesthetically pleasing appearance than those made just from metal. In another alternative embodiment, the bridge structure and outer guide plate, in addition to being made of any of various moldable resins, might consist of other composites capable of being machined, thermally formed or laid into a mold-like fixture, such as phenolic or glass fiber- or carbon fiber-reinforced cold-setting resin.

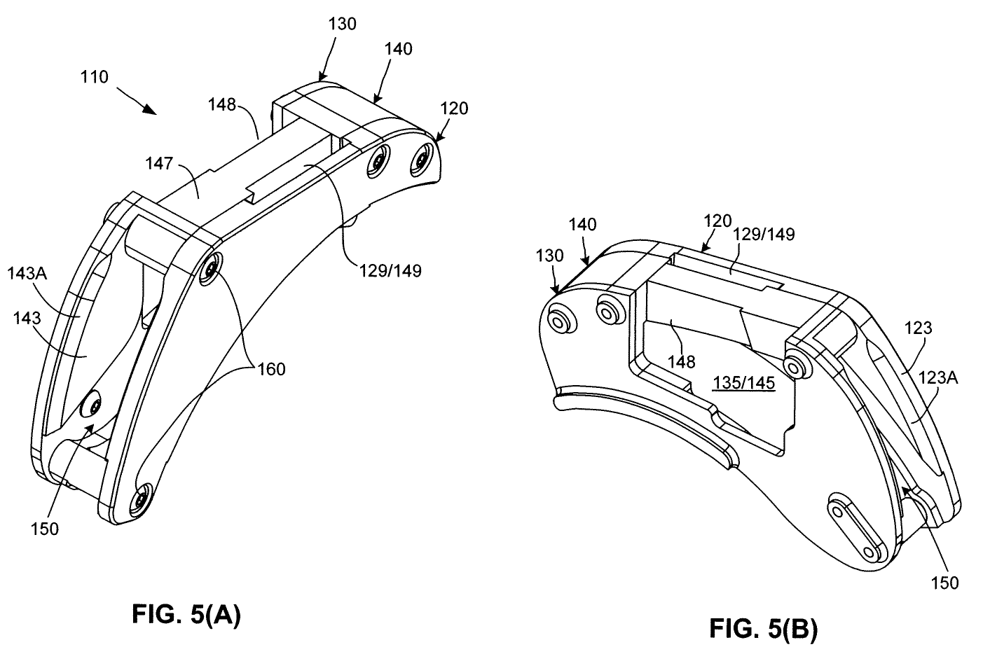

FIGS. 5(A) and 5(B) are front and back side perspective views showing the guide structure 110 in an assembled state (i.e., with outer guide plate 120 and bridge structure 140 secured to anchor plate 130 by way of screws 160. A chain guide channel 150 for controlling the bicycle chain is defined between outer guide plate 120 and the inner guide plate formed by bridge structure 140 and anchor plate 130, and at its upper end by a lower surface of bridge 147. Chain inlet surfaces 123A and 143A, which are located along the edges of front portion 123 of outer guide plate 120 and upper guide plate portion 143 of bridge structure 140, are relieved with deep chamfers to minimize friction during pedaling. This geometry, in conjunction with the use of low friction materials (e.g., polycarbonate) serves to reduce noise generated by the chain rubbing on either of the inner or outer guide plate structures. Note that U-shaped groove 135 and central groove 145 combine to form an open region for receiving bracket 95 of derailleur 90 (see FIG. 2 and assembly description below). In addition, upper grooves 148 and 129/149 form slots that are defined along the sides of bridge 147 to accommodate the upper end of metal guide blades 97 and 98 and upper metal bridge 99U (see FIG. 2 and assembly description below).

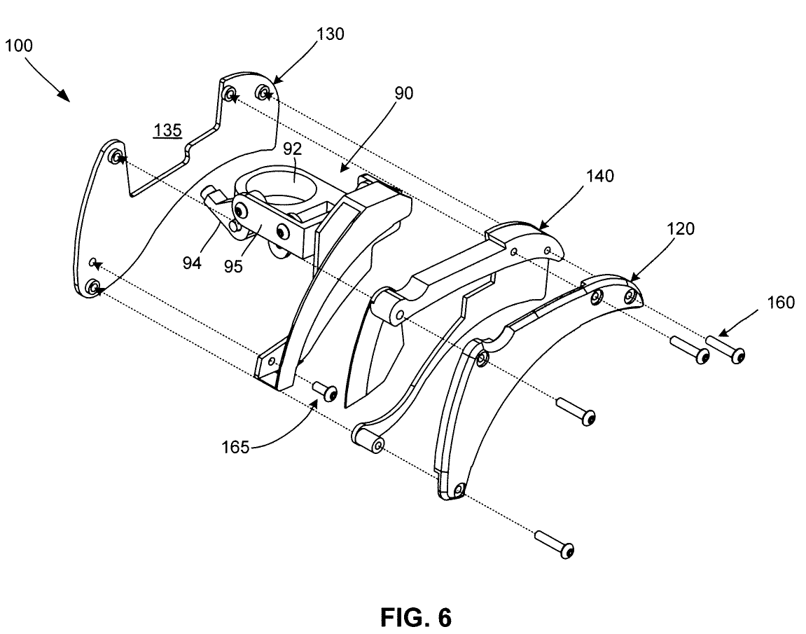

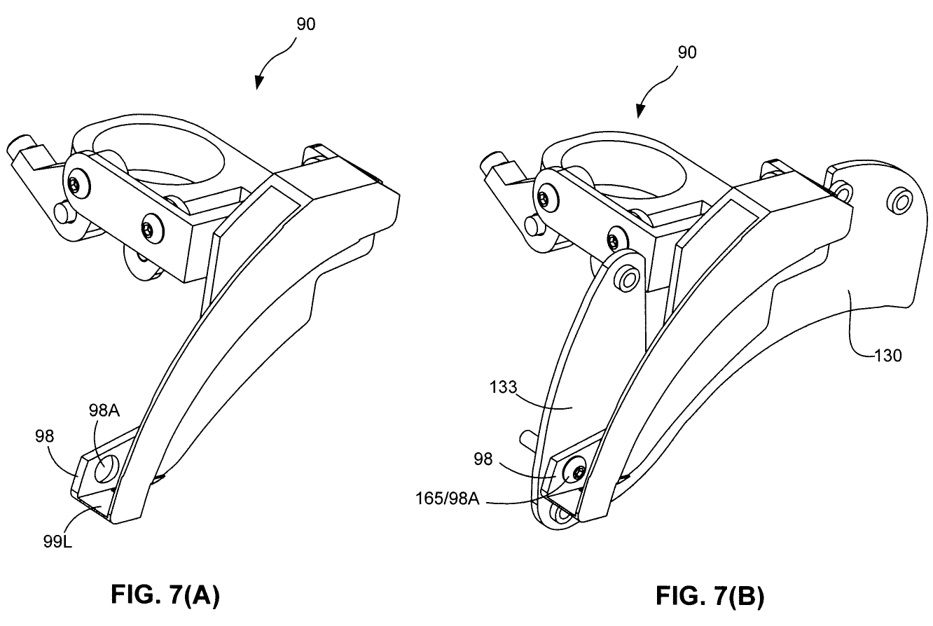

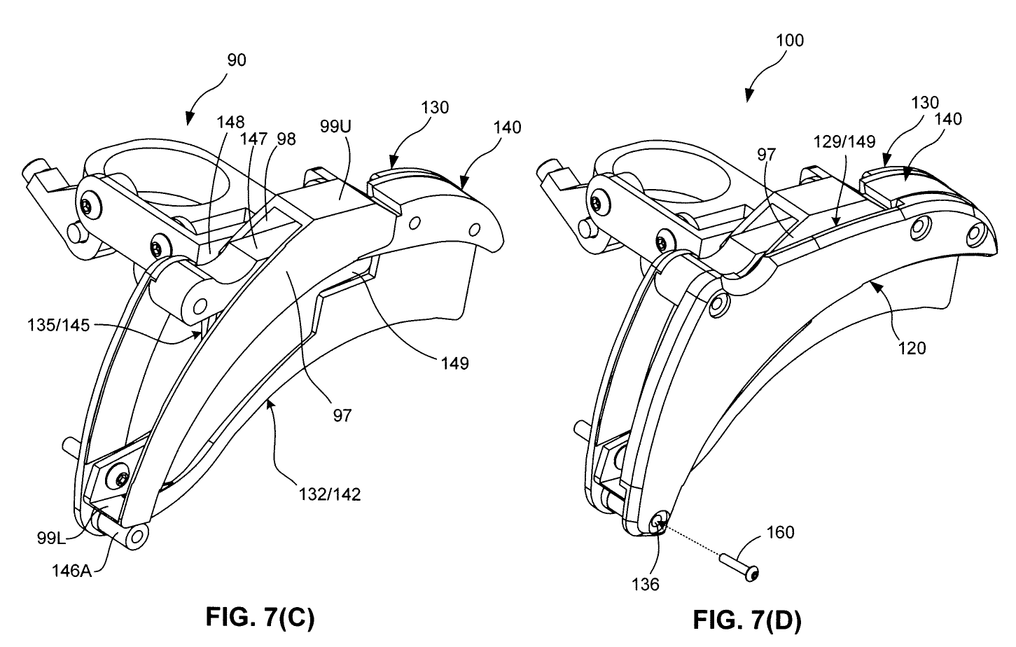

FIG. 6 is an exploded perspective view showing multiple sprocket chain guide apparatus 100 prior to assembly. Note that, as described below with reference to FIGS. 7(A) to 7(D), anchor plate 130 is mounted onto a first side of derailleur 90 using small screw 165 such that base member 92, gear shift mechanism 94 and frame 95 are received inside U-shaped groove 135, and then bridge structure 140 and outer guide plate 120 are mounted onto anchor plate 130 using long screws 160 in the order indicated in FIG. 6.

Referring to FIG. 7(A), in one embodiment a modification to conventional derailleur 90 is necessary to attach anchor plate 130. A rivet connecting the lower metal bridge 99L to inner guide blade 98 at the bottom of metal cage 96 must be removed, and the original rivet hole 98A is used to secure inner guide blade 98 to front portion 133 of anchor plate 130 using screw 165, as shown in FIG. 7(B), thereby securing derailleur 90 to anchor plate 130. When such a rivet is not present, hole 98A must otherwise be formed, for example, by drilling through inner guide blade 98. Next, as shown in FIG. 7(C), bridge structure 140 is mounted onto the subassembly made up of derailleur 90 and anchor plate 130 such that bridge 147 is located below upper metal bridge 99U (i.e., such that upper ends of metal guide blades 98 and 97 extend through grooves 148 and 149, respectively), and such that cylindrical spacer 146A is located below lower metal bridge 99L. Note that, although not clearly shown in the figures, openings 135 and 145 are formed such that inner metal guide blade 98 is exposed inside channel 150 (i.e., such that an inside surface of metal guide blade 98 contacts the chain during operation). Further note that, when properly assembled, lower curved surface 132 of anchor plate 130 matches and aligns with lower curved surface 142 of bridge structure 140 to provide a combined curved surface 132/142. Finally, as indicated in FIG. 7(D), outer guide plate 120 is mounted and secured onto bridge structure 140 by way of long screws 160 (one shown) to complete the assembly of multiple sprocket chain guide apparatus 100. Note that outer metal guide blade 97 is thus positioned inside slot 129/149 (discussed above with reference to FIGS. 5(A) and 5(B)).

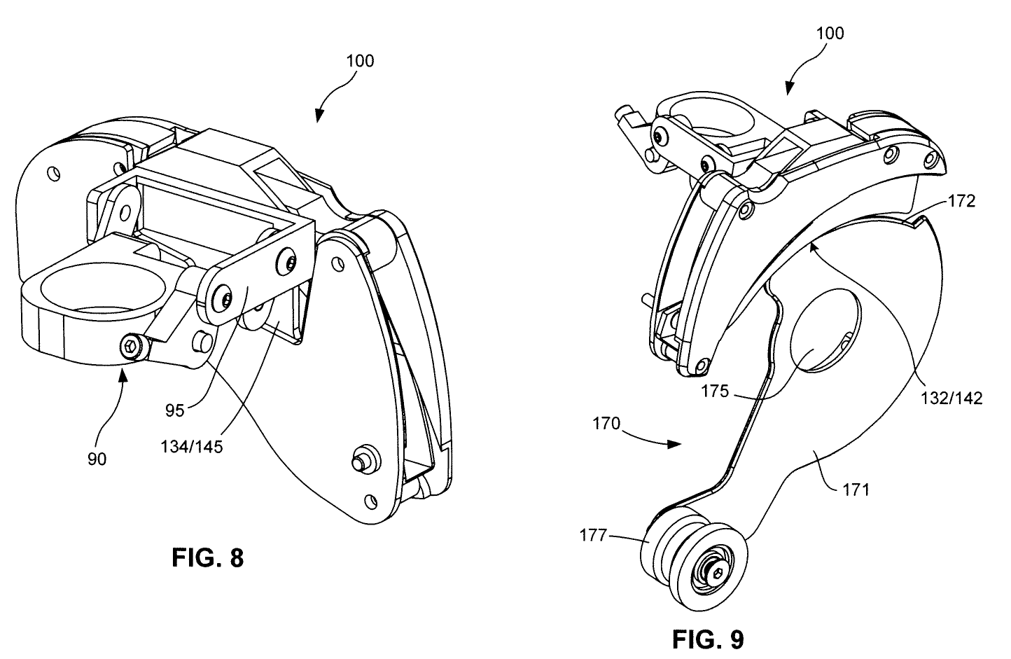

FIG. 8 is a rear side perspective view showing multiple sprocket chain guide apparatus 100 in the assembled state. This view clearly illustrates how bracket 95 of derailleur 90 is received inside slots 135/145 to facilitate operation of multiple sprocket chain guide apparatus 100.

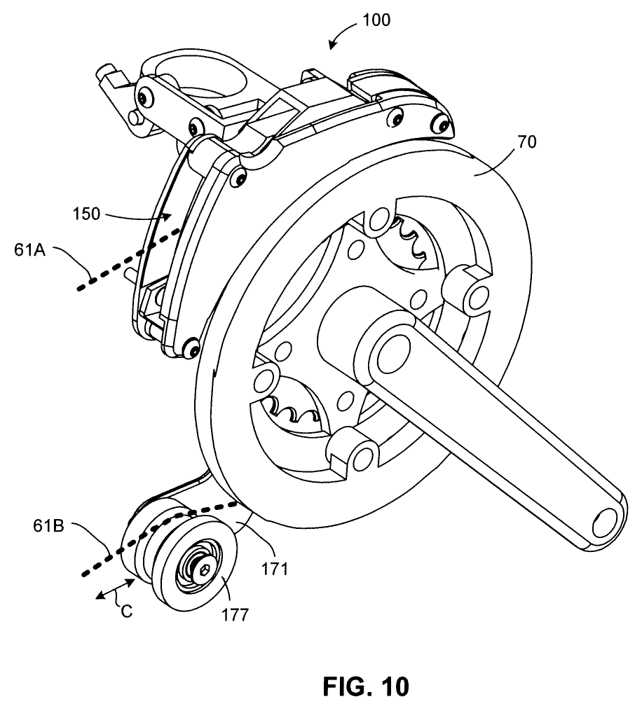

FIGS. 9 and 10 are front side perspective views showing multiple sprocket chain guide apparatus 100 in relation to a back plate and roller assembly 170. FIG. 9 shows multiple sprocket chain guide apparatus 100 and back plate and roller assembly 170 alone, while FIG. 10 shows the relationship between multiple sprocket chain guide apparatus 100, back plate and roller assembly 170, chain 61, sprockets/gears and outside bash guard 70. As indicated in FIG. 10, a first chain portion 61A enters channel 150 formed by multiple sprocket chain guide apparatus 100, a second chain portion (not shown) is trained over a selected front sprocket (behind bash guard 70), and a third chain portion 61B exits the front sprockets by way of roller 177, which is utilized to apply tension to chain portion 61B during operation to further enhance the anti-derailing function of multiple sprocket chain guide apparatus 100. Referring to FIG. 9, back plate 171 is machined from 6061 aluminum and mounts to the bicycle frame around the bottom bracket shell (BB Shell) using set screws or a standard ‘chain guide mount’ feature found on some frames (Refer to Int'l Standard for Chain Guides', also known as ISCG Mounts; see www.isco.org, which describes a three-bolt mounting scheme for mounting inner chain guide plates; see also www.isco05.com which updates the original ISCG standard for different bottom bracket types used in downhill/freeride applications). Back plate 171 has a curved upper surface 172 that, as described below, matches the combined curved surface 132/142 of anchor plate 130 and bridge structure 140 (see FIG. 7(C), discussed above). A central hole 175 is utilized to facilitate mounting onto the bicycle frame. A grooved plastic roller 177 with an internal bearing for easy rotation is rotatably mounted onto a lower end of back plate 171. As indicated in FIG. 10, roller 177 is mounted to back plate 171 by way of a horizontal slot and fixture (not shown) such that roller 177 can be adjustably positioned relative to back plate 171 in the direction of arrow C to provide a high level of chain tension as it exits the front sprockets and travels toward bicycle's rear derailleur. The combined system shown in FIGS. 9 and 10 works together to provide unparalleled shifting precision in all riding conditions.

Referring again to FIG. 10, during operation, as chain portion 61A travels into and through channel 150 of guard apparatus 100, it is restricted from all sides and channeled to the selected sprocket. The surface area of the inner guide plate of guard apparatus 100 (i.e., formed by anchor plate 130 and the side portions of bridge structure 140) is approximately 2.5× greater than inner metal guide blade 98. Similarly, the surface area of the outer guide plate 120 is approximately 3× greater than outer metal guide blade 97, and the surface area of bridge 147 (i.e., facing into channel 150) provides 4× more surface area than upper metal bridge 99U of derailleur 90. This increased channel surface area greatly enhances the ability of guard apparatus 100 to control the chain and calm any chain whip before it comes in contact with the selected front sprocket. Unlike previous chain guides that only allowed the use of one sprocket, guard apparatus 100 allows a bicycle rider to take full advantage of a dual ring chain configuration which enhances the rider's ability to maneuver steeper terrain and promotes safety.

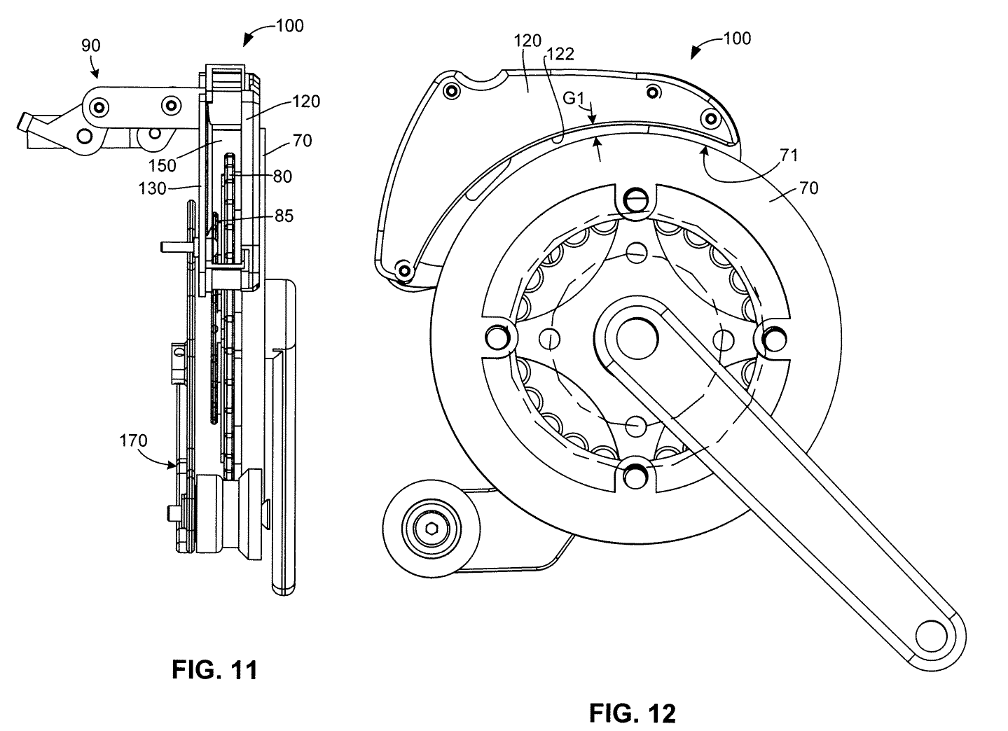

FIGS. 11 and 12 are end and front elevation views showing multiple sprocket chain guide apparatus 100 and back plate/roller assembly 170 in a first gear position that channel 150 is aligned with and guides (biases) the chain (not shown) onto the outer (larger) sprocket 80. In this first position, outer guide plate 120 is positioned over bash guard 70 such that, as indicated in FIG. 12, a gap G1 defined between curved surface of outer guide plate 120 and peripheral edge 71 of bash guard 70 is smaller than the height of the drive chain (not shown), thus preventing derailment of the chain. In addition, the inner guide plate (e.g., anchor plate 130) is positioned over the inner (smaller) sprocket 85 in this gear position, whereby the chain is prevented from undesirably dropping onto sprocket 85.

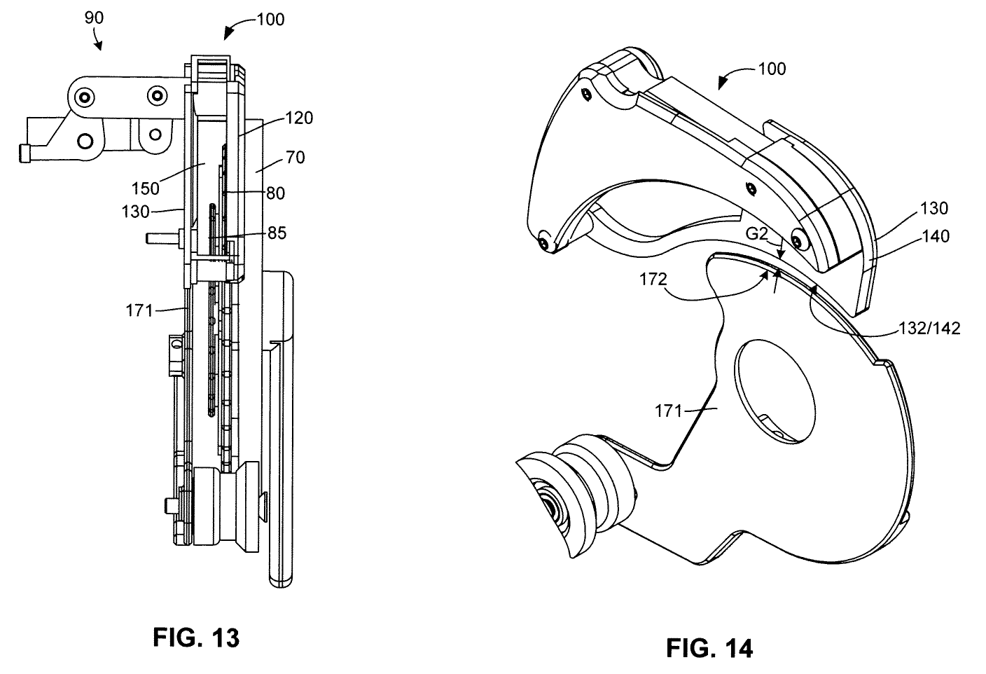

FIGS. 13 and 14 are end elevation and front partial perspective views showing multiple sprocket chain guide apparatus 100 and back plate/roller assembly 170 in a second gear position that channel 150 is aligned with and guides the chain (not shown) onto the inner (smaller) sprocket 85. In this gear position, as shown in FIG. 14, inner guide plate (e.g., anchor plate 130 and the side portion of bridge structure 140) is positioned over back plate 171 such that a gap G2 is defined between combined curved surface 132/142 and curved edge 172 of back plate 170 is smaller than the height of the drive chain (not shown), thus preventing derailment of the chain. In addition, the outer guide plate 120 is positioned over the outer (larger) sprocket 80 in this gear position, whereby the chain is prevented from undesirably shifting onto sprocket 80.

Although the present invention has been described with respect to certain specific embodiments, it will be clear to those skilled in the art that the inventive features of the present invention are applicable to other embodiments as well, all of which are intended to fall within the scope of the present invention. For example, although the present invention is described as including a chain guide that is mounted onto a conventional derailleur, the present invention may be incorporated into a derailleur that is customized to include the various features described herein (e.g., by replacing metal cage 96 of conventional derailleur 90, shown in FIG. 2, with a guide structure similar to guide structure 110, described above). Thus, the appended claims are not intended to be limited by the presently preferred embodiment described herein unless otherwise specified by the claim limitations.

1. A multiple sprocket chain guide apparatus for use with a bicycle drive system including a pedal crank rotatably mounted on a bicycle frame, a disk-shaped bash guard fixedly connected to the pedal crank, first and second front sprockets fixedly connected to the pedal crank and located between the first and second bash guards, a drive chain having a height that is engaged with a selected one of the first and second front sprockets, wherein multiple sprocket chain guide apparatus comprises:
a guide structure including:
a first guide plate having a first curved surface,
a second guide plate, and
a bridge rigidly connected between the first and second guide plates, whereby the bridge and the first and second guide plates define a channel sized to receive said drive chain; and
means for moving the guide structure between:
a first position in which the channel is positioned over the first sprocket, the first guide plate is positioned over the bash guard such that a first gap defined between the first curved surface and the peripheral edge of the first bash guard is smaller than the height of the drive chain, and the second guide plate is positioned over the second sprocket, whereby the drive chain is biased onto the first sprocket, and
a second position in which the channel is positioned over the second sprocket and the first guide plate is positioned over the first sprocket, whereby the drive chain is biased onto the second sprocket.

2. The multiple sprocket chain guide apparatus of claim 1, wherein one or more of the first and second guide plates and the bridge structure comprise one of a hard plastic, a carbon fiber composite, a phenolic fiber, a glass fiber and a carbon fiber-reinforced cold-setting resin.

3. The multiple sprocket chain guide apparatus of claim 1, wherein one or more of the first and second guide plates comprises a metal.

4. The multiple sprocket chain guide apparatus of claim 1,
wherein said means for moving the guide structure comprises a derailleur having a base, means for fixedly connecting the base to the bicycle frame, a movable cage having an inner blade and outer blade, a bridge extending between the inner and outer blades, and a gear shifting mechanism for selectively moving the movable cage between the first and second positions, and
wherein the guide structure is fixedly mounted onto the movable cage.

5. The multiple sprocket chain guide apparatus of claim 1, further comprising a back plate disposed on the bicycle frame adjacent to the second sprocket, wherein when the guide structure is in the second position, the second guide plate is positioned over the back plate such that a second gap defined between a second curved surface of the second guide plate and a curved peripheral edge of the back plate is smaller than the height of the drive chain.

6. A multiple sprocket chain guide apparatus for use with a bicycle drive system, the bicycle drive system including a pedal crank rotatably mounted to a bicycle frame, a disk-shaped bash guard fixedly connected to the pedal crank and having a peripheral edge, first and second front sprockets fixedly connected to the pedal crank such that the first front sprocket is located between the second front sprocket and the bash guard, a drive chain having a predetermined height, and a front derailleur having a base member fixedly connected to the bicycle frame, a movable cage having first and second metal guide blades disposed on opposite sides of the drive chain, and a gear shifting mechanism for moving the movable cage between a first position in which the movable cage biases the drive chain to engage the first front sprocket, and a second position in which the movable cage biases the chain drive to engage the second front sprocket, wherein multiple sprocket chain guide apparatus comprises:
a first guide plate fixedly connected to the movable cage of the derailleur such that the first guide plate extends from a peripheral edge of the first metal guide surface, wherein the first guide plate has a first curved surface,
a second guide plate fixedly connected to the movable cage such that the second guide plate extends from a peripheral edge of the second metal guide surface, wherein the second guide plate has a second curved surface, and
a bridge structure rigidly connected between the first and second guide plates, whereby the bridge structure and the first and second guide plates define a channel sized to receive said drive chain,
wherein when the movable cage of the front derailleur is in the first position, the first guide plate is positioned over the first bash guard such that an elongated gap defined between the first curved surface and the peripheral edge of the first bash guard is smaller than the height of the drive chain.

7. The multiple sprocket chain guide apparatus of claim 6, wherein one or more of the first and second guide plates and the bridge structure comprise one of a hard plastic, a carbon fiber composite, a phenolic fiber, a glass fiber and a carbon fiber-reinforced cold-setting resin.

8. The multiple sprocket chain guide apparatus of claim 6, wherein one or more of the first and second guide plates comprises a metal.

9. The multiple sprocket chain guide apparatus of claim 6, further comprising a back plate disposed on the bicycle frame adjacent to the second sprocket, wherein when the guide structure is in the second position, the second guide plate is positioned over the back plate such that a second gap defined between a second curved surface of the second guide plate and a curved peripheral edge of the back plate is smaller than the height of the drive chain.

10. A multiple sprocket chain guide apparatus for use with a bicycle drive system, the bicycle drive system including a pedal crank rotatably mounted to a bicycle frame, a disk-shaped bash guard fixedly connected to the pedal crank and having a peripheral edge, first and second front sprockets fixedly connected to the pedal crank such that the first front sprocket is located between the second front sprocket and the bash guard, a drive chain having a predetermined height, wherein multiple sprocket chain guide apparatus comprises:
a front derailleur having a base member fixedly connected to the bicycle frame, a movable cage having first and second metal guide blades disposed on opposite sides of the drive chain, and a gear shifting mechanism for moving the movable cage between a first position in which the movable cage biases the drive chain to engage the first front sprocket, and a second position in which the movable cage biases the chain drive to engage the second front sprocket; and
a guide structure including:
a first guide plate fixedly connected to the movable cage of the derailleur such that the first guide plate extends from a peripheral edge of the first metal guide surface, wherein the first guide plate has a first curved surface,
a second guide plate fixedly connected to the movable cage such that the second guide plate extends from a peripheral edge of the second metal guide surface, wherein the second guide plate has a second curved surface, and
a bridge structure rigidly connected between the first and second guide plates, whereby the bridge and the first and second guide plates define a channel sized to receive said drive chain,
wherein when the movable cage of the front derailleur is in the first position, the first guide plate is positioned over the first bash guard such that an elongated gap defined between the first curved surface and the peripheral edge of the first bash guard is smaller than the height of the drive chain, and the second guide plate is positioned over the second sprocket.

11. The multiple sprocket chain guide apparatus of claim 10, wherein one or more of the first and second guide plates and the bridge structure comprise one of a hard plastic, a carbon fiber composite, a phenolic fiber, a glass fiber and a carbon fiber-reinforced cold-setting resin.

12. The multiple sprocket chain guide apparatus of claim 10, wherein one or more of the first and second guide plates comprises a metal.

13. The multiple sprocket chain guide apparatus of claim 10, further comprising a back plate disposed on the bicycle frame adjacent to the second sprocket, wherein when the guide structure is in the second position, the second guide plate is positioned over the back plate such that a second gap defined between a second curved surface of the second guide plate and a curved peripheral edge of the back plate is smaller than the height of the drive chain.
